(19) United States
(12) Patent Application Publication
(10) Pub. No.: US 2008/0302827 A1
(43) Pub. Date: Dec. 11, 2008

(54) SPRAY DISPENSER

(76) Inventors: Donald L. Gerrish, Mankato, MN (US); Charles E. Boyer, III, Elyslan, MN (US); Dennis Femrite, Andover, MN (US)

Correspondence Address: COLOPLAST CORP.;I.P. DEPARTMENT, U.S. OPERATIONS, P.O. BOX 580800, MINNEAPOLIS, MN, 55456-0800, US

(21) Appl. No.: 11/758,771

(22) Filed: Jun. 6, 2007

(51) Int. Cl. B67D 5/64; G01F 11/00

(52) U.S. Cl. 222/173; 222/175; 222/321.9

(57) ABSTRACT

A spray dispenser for containing and dispensing a fluid comprises a barrel to contain the fluid and a cap portion connected to the barrel. The cap portion includes a pump means. A fluid conduit is within the barrel and connected to the pump means. A clip is connected to a selected one of the barrel and the cap portion, such that the spray dispenser is in an inverted orientation when in place in a pocket by way of the clip. Alternatively, a plate type-member and a removable cap cover may be selectively employed to maintain the spray dispenser in an inverted orientation when not in use.

### FIELD OF THE INVENTION

The present invention relates generally to spray dispensers. The invention relates specifically to a spray dispenser that minimizes clogging and drying of a fluid therein.

### BACKGROUND OF THE INVENTION

Spray dispensers are well known, and have been in wide use. Known spray dispensers have been commercially provided in many configurations for ease of use and specific applications. For example some spray dispensers, such as for cleaning products and herbicides, incorporate a bottle to contain a cleaning or herbicide liquid to be sprayed with a trigger-actuated gun-like spray means. Alternatively, some spray dispensers are designed to be relatively small or “pocket-sized”, to allow for compact storage when not in use. An example of such a pocket-sized spray dispenser is illustrated in U.S. Pat. No. 7,178,696 to Larsen et al.

Attempts have been made to utilize pocket-sized spray dispensers with topical skin protectant fluid compositions (hereinafter, “topical skin protectants”) as known in the medical arts. Topical skin protectants have been used, inter alia, for the treatment and protection of bedridden patients' skin where irritation from moisture and waste is problematic, painful, and unfortunately commonplace. As used here throughout, the term “protectant” is intended to include any fluid having properties of a sealant, a barrier, a so-called “liquid bandage”, or any other desired characteristics which tend to benefit skin after application thereto. However, topical skin protectants in pocket-sized spray dispensers have experienced several deficiencies. Among these problems is a tendency of nozzles in pump means of the spray dispensers to become dry and clog when not in regular, frequent use. This clogging tendency is believed to be due to inherent chemical characteristics of many topical skin protectants which become relatively dry after being applied to patients' skin; thus, when these types of fluids are not in an overall solution—such as when a somewhat thin film of residual fluid coats a nozzle after use of the dispenser and that fluid at the nozzle is isolated from a larger fluid supply in the dispenser—they tend to dry and clog the pump means.

Thus, there has existed a long-felt need for a spray dispenser having a nozzle that is not prone to drying and clogging, when used with a fluid such as a topical skin protectant.

### SUMMARY OF THE INVENTION

In accordance with basic aspects of the present invention, a spray dispenser for containing and dispensing a fluid comprises a barrel to contain the fluid and a cap portion connected to the barrel. The cap portion includes a pump means. A fluid conduit is within the barrel and connected to the pump means. A clip is connected to a selected one of the barrel and the cap portion, such that the spray dispenser is in an inverted orientation when in place in a pocket by way of the clip. Alternatively, a plate type-member and a removable cap cover may be selectively employed to maintain the spray dispenser in an inverted orientation when not in use.

### BRIEF DESCRIPTION OF THE DRAWINGS

FIG. 1 is an illustration of a known spray dispenser for containing and dispensing a fluid.

FIG. 2 is an illustration of one example of a spray dispenser for containing and dispensing a fluid, of the present invention.

FIG. 3 is an illustration of the spray dispenser of FIG. 2, in place in a user's pocket.

FIG. 4A is an illustration of another example of a spray dispenser for containing and dispensing a fluid, of the present invention.

FIG. 4B is an illustration of a further example of a spray dispenser for containing and dispensing a fluid, of the present invention.

FIG. 4C is an illustration of a yet further example of a spray dispenser for containing and dispensing a fluid, of the present invention.

### DETAILED DESCRIPTION OF THE INVENTION

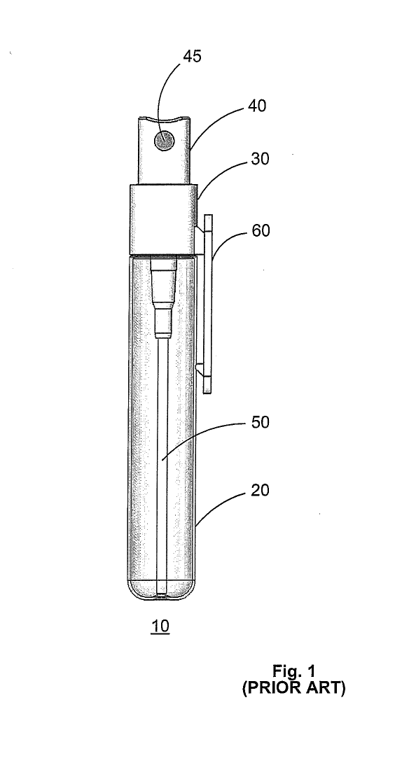

Illustrated in FIG. 1 is an example of a spray dispenser 10 of the prior art, for containing and dispensing a fluid. Spray dispenser 10 includes a barrel 20 to contain the fluid (not depicted), a cap portion 30 connected to barrel 20, a pump means 40 within cap portion 30, a fluid conduit 50 within barrel 20, and a clip 60 connected to cap portion 30. Pump means 40 includes a nozzle 45. Conduit 50 is connected to pump means 40 so that in operation of dispenser 10 by way of pump means 40, fluid within barrel 20 is drawn into conduit 50 and dispensed outwardly as a spray through nozzle 45. Clip 60 is provided so that dispenser 10 may be conveniently placed in a pocket thereby, similarly to, for example, a writing implement with a pocket clip such as a typical ball-point pen.

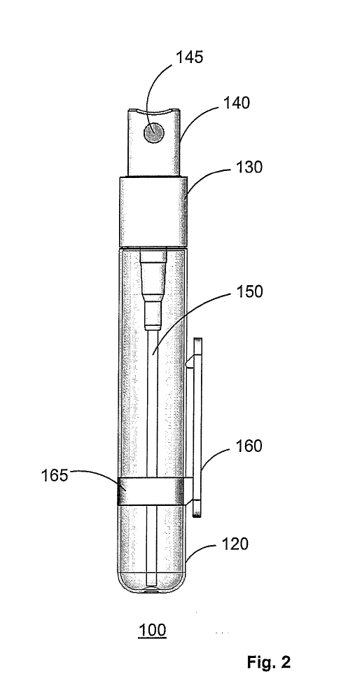

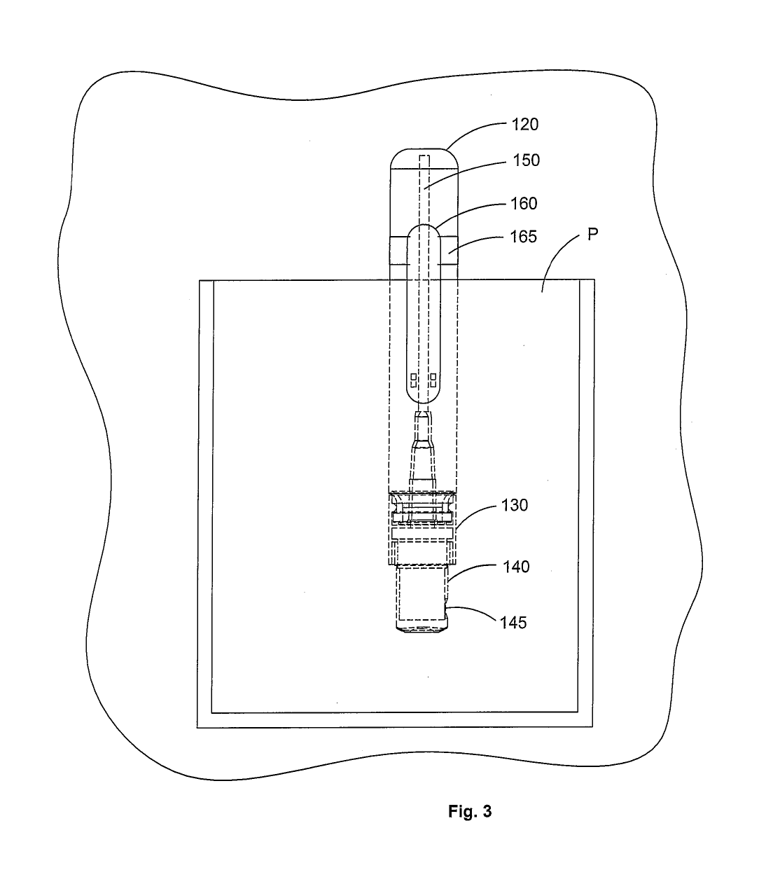

Illustrated in FIG. 2 is an example of a spray dispenser 100 of the present invention, for containing and dispensing a fluid. Spray dispenser 100 includes a barrel 120 to contain the fluid (not depicted), a cap portion 130 connected to barrel 120, a pump means 140 within cap portion 130, a fluid conduit 150 within barrel 120, and a clip 160 connected to barrel 120 by way of band 165. Pump means 140 includes a nozzle 145. Conduit 150 is connected to pump means 140 so that in operation of dispenser 100 by way of pump means 140, fluid within barrel 120 is drawn into conduit 150 and dispensed outwardly as a spray through nozzle 145. Clip 160, and band 165 which (i) is connected to clip 160 and (ii) encompasses a diameter of barrel 120, are provided so that dispenser 100 may be conveniently placed in an inverted orientation in a user's pocket thereby as depicted in FIG. 3 and compared to dispenser 10 of the prior art.

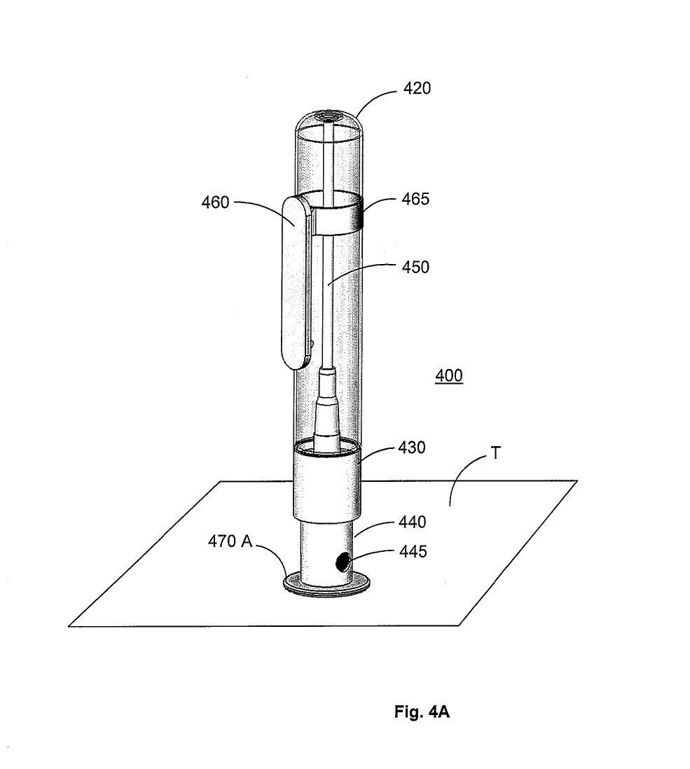

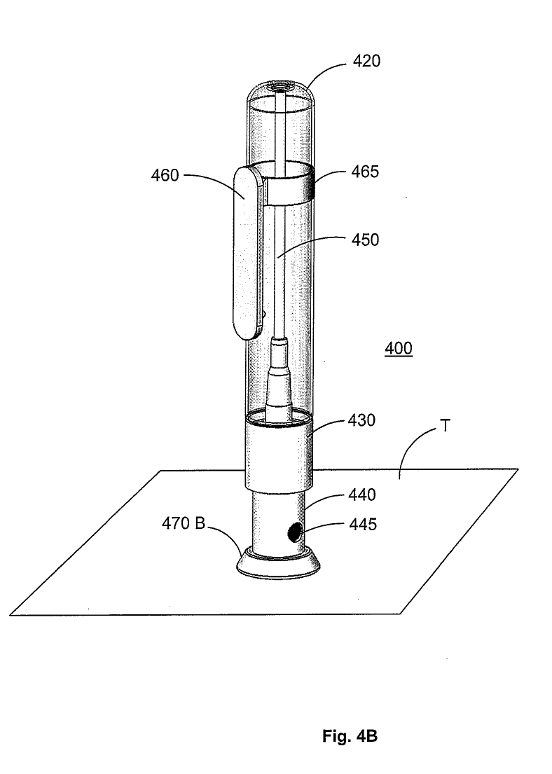

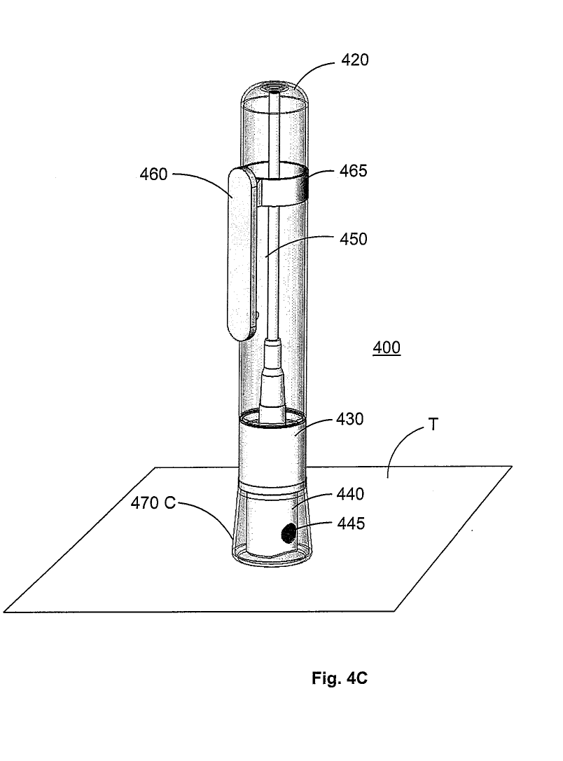

Illustrated in FIGS. 4A-C are alternative examples of a spray dispenser 400 of the present invention, for containing and dispensing a fluid. Spray dispenser 400 includes a barrel 420 to contain the fluid (not depicted), a cap portion 430 connected to barrel 420, a pump means 440 within cap portion 430, a fluid conduit 450 within barrel 420, and a clip 460 connected to barrel 420 by way of band 465. Pump means 440 includes a nozzle 445. Conduit 450 is connected to pump means 440 so that in operation of dispenser 400 by way of pump means 440, fluid within barrel 420 is drawn into conduit 450 and dispensed outwardly as a spray through nozzle 445. Clip 460, and band 465 which (i) is connected to clip 460 and (ii) encompasses a diameter of barrel 420, are provided so that dispenser 400 may be conveniently placed in an inverted orientation in a pocket (as depicted in FIG. 3 regarding dispenser 100). With particular regard now to FIG. 4A, pump means 440 of alternative dispenser 400 optionally includes a flat plate-type member 470A coupled thereto. Member 470A is provided so that dispenser 400 may be maintained in an inverted orientation when placed on a flat surface T, such as a patient's bedside table, when not in use. Turning to FIG. 4B, pump means 440 of alternative dispenser 400 optionally includes a “flared” or partially conically-shaped plate-type member 470B coupled thereto. Like member 470A, member 470B is provided so that dispenser 400 may be maintained in an inverted orientation on a flat surface when not in use.

In FIG. 4C, pump means 440 of alternative dispenser 400 optionally includes a removable cap cover 470C. Like members 470A-B, cover 470C is provided so that dispenser 400 may be maintained in an inverted orientation on a flat surface when not in use.

Regardless of a particular configuration or shape of accessories like members 470A-B and cover 470C, it is to be appreciated that any desired shapes thereof may be employed in particular embodiments of the dispensers of the present invention; and such geometries only depend upon provision of sufficient stabilities therefrom for the dispensers when not in use and placed on desired flat surfaces. For example, members 470A-B and cover 470C could have rectangular cross-sections rather than circular cross-sections as illustrated.

Although not illustrated, the fluid contained within barrels 120 and 420 could advantageously be a sprayable topical skin protectant for general skin care such as, for example, the various COLOPLAST® PREP™ brand topical skin protectants from Coloplast A/S of Denmark. Suitable fluids may also be characterized as (i) being not limited in application to a specific area of a patient's body, (ii) optionally including, alone or in combination, antifungal, odor control, pain relief, and skin conditioning agents, (iii) adhering well to skin and providing a good barrier in an environment of moisture and waste, and (iv) having detectable transparency. Furthermore, the fluid could include a carrier solvent having a molecular weight in a range of about 16 g/mol. to 200 g/mol.

It is to be appreciated from the foregoing disclosure that the present invention satisfies the long-felt need for a spray dispenser having a nozzle that is not prone to drying and clogging, when used with a fluid such as a topical skin protectant. It is to be understood that this novel and inventive achievement is provided in dispensers 100/400 by (i) fluid being substantially maintained within conduits 150/450 immediately adjacent to nozzles 145/445 while (ii) dispensers 100/400 substantially remain in an inverted orientation when not in use, as aforedescribed.

With reference to FIGS. 2, 3, and 4A-C, it is to be understood that several alternatives may be provided in the spray dispensers of the present invention. For example, bands 165/465 could fully (as shown) or partially encompass barrels 120/420. Clips 160/460 could be bonded directly to barrels 120/420 or to cap portions 130/430, thereby obviating a need for bands 165/465. Cap portions 130/430 and pump means 140/440 could be provided integrally together, acting as unitary components of dispensers 100/400. Dispensers 400 could include clip 460 and members 470A-B or cover 470C together as shown or separately, as alternative embodiments. Any means to keep the dispenser inverted could be employed, such as a holster or other accessory. Then, clips 160/460 and the configuration of cap portion 130/430 each become purely optional. The fluids to be sprayed from dispensers 100/400 could be any compositions that are capable of being sprayed, where it is desirable or necessary to inhibit drying or clogging therein. Also, although examples of spray dispensers of the present invention have been described as pocket-sized, any size may be provided as desired for a particular use (e.g., a larger and possibly not pocket-sized dispenser for frequent, high-volume applications, and a smaller “micro-sized” dispenser for “one-shot” applications).

While the present invention has been particularly shown and described with reference to the accompanying specification and drawings, it will be understood however that other modifications thereto are of course possible; and all of which are intended to be within the true spirit and scope of the present invention. It should be appreciated that (i) components, dimensions, and other particulars of example embodiments of the invention aforedescribed may be substituted for others that are suitable for achieving desired results, (ii) various additions or deletions may be made thereto, and (iii) features of the foregoing examples may also be made in combinations thereof. It is also to be understood in general that any suitable alternatives may be employed to provide the spray dispenser for containing and dispensing a fluid of the present invention.

Lastly, of course, the choice of compositions, sizes, and strengths of various aforementioned elements of the present invention are all a matter of design choice depending upon intended uses thereof.

Accordingly, these and other various changes or modifications in form and detail of the present invention may also be made therein, again without departing from the true spirit and scope of the invention as defined by the appended claims.

What is claimed is:

1. A spray dispenser for containing and dispensing a fluid, said spray dispenser comprising:
a barrel to contain the fluid;
a cap portion connected to said barrel, said cap portion including a pump means;
a fluid conduit within said barrel and connected to said pump means; and
a clip connected to a selected one of said barrel and said cap portion, arranged such that said spray dispenser is in an inverted orientation when in place in a pocket by way of said clip.

2. A spray dispenser for containing and dispensing a fluid, said spray dispenser comprising:
a barrel to contain the fluid;
a cap portion connected to said barrel, said cap portion including a pump means; and
a fluid conduit within said barrel and connected to said pump means,
wherein said cap portion includes a plate-type member such that said spray dispenser is in an inverted orientation when placed on a flat surface by way of said cap portion and said plate-type member.

3. A spray dispenser for containing and dispensing a fluid, said spray dispenser comprising:
a barrel to contain the fluid;
a cap portion connected to said barrel, said cap portion including a pump means; and
a fluid conduit within said barrel and connected to said pump means,
wherein said cap portion includes a removable cap cover such that said spray dispenser is in an inverted orientation when placed on a flat surface by way of said cap portion and said removable cap cover.

4. The spray dispenser of claim 1, wherein said fluid is a topical skin protectant.

5. The spray dispenser of claim 2, wherein said fluid is a topical skin protectant.

6. The spray dispenser of claim 3, wherein said fluid is a topical skin protectant.

7. The spray dispenser of claim 1, wherein said fluid includes a carrier solvent having a molecular weight in a range of about 16 g/mol. to 200 g/mol.

8. The spray dispenser of claim 2, wherein said fluid includes a carrier solvent having a molecular weight in a range of about 16 g/mol. to 200 g/mol.

9. The spray dispenser of claim 3, wherein said fluid includes a carrier solvent having a molecular weight in a range of about 16 g/mol. to 200 g/mol.
